(19) United States
(12) Patent Application Publication
(10) Pub. No.: US 2007/0274232 A1
(43) Pub. Date: Nov. 29, 2007

(54) Method, Communication Device and System for Detecting Neighboring Nodes in a Wireless Multihop Network Using Ndp

(75) Inventors: Leif Axelsson, Hovas (SE); Henrik Riomar, Floda (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (pub), Stockholm (SE)

(21) Appl. No.: 11/547,605

(22) PCT Filed: Jun. 14, 2004
(86) PCT No.: PCT/SE04/00930

§ 371 Date: Oct. 4, 2006

(30) Foreign Application Priority Data
Apr. 5, 2004 (SE) PCT/SE04/00537

(51) Int. Cl. H04L 12/28

(52) U.S. Cl. 370/254

(57) ABSTRACT

A method is presented for neighbor discovery in a wireless multihop packet based communication network using Internet Protocol version 6 (IPv6) wherein the network is built up by client and/or server devices and/or infrastructure devices, network traffic is based on using NDP forwarding and rebroadcasting to locate devices in such a network architecture. The invention also includes devices for such a network and the complete communication system is described.

### FIELD OF THE INVENTION

The present invention relates to a communication network, specially a packet based network in an ad hoc network using Internet Protocol version 6 (IPv6), and in particular a routing scheme using additional neighbor discovery protocol (NDP) message types.

### BACKGROUND OF THE INVENTION

Wireless communication between mobile users is becoming more and more popular as devices and technology is developed. The infrastructure roll out is expanding within both telecom systems and data network systems. Today also the telecom systems are increasingly using packet switched networks and the trend is clear towards this scheme of packet based routing. This system has been used for many years in the data networks and thus many standardized routing protocols exist for this purpose. However, they are not prepared for rapidly changing network topographies like for instance so called ad hoc networks.

Wireless ad hoc networks are characterized in that they do not have the same static nature as an ordinary wired network infrastructure, the ad hoc based network do not have a centralized control and is often created in a spontaneous manner. It maintains control through a decentralized concept. Nodes can be connected or disconnected in an uncontrolled manner as compared to standard fixed network architectures; the nodes may come and go quickly which leads to a dynamically changing network topology. In some cases such ad hoc networks are formed by user/client devices themselves as infrastructure components. These components are then truly mobile in the sense that the users move around, in and out of a network cell, and therefore the infrastructure will move around and change dynamically accordingly. This is an exciting and promising way of building an infrastructure; however, it sets very high demands on the routing protocol.

Other problems in a wireless environment are due to radio specific questions that will degrade the performance and efficiency of the network flow. There may be fading problems due to the movement of infrastructure nodes or movement of objects in the radio environment, and there may be problems due to interference from other radio sources within range.

These kinds of network topographies have been used in the military environment but are now migrating into the civilian area as well. Wireless systems are now used to rapidly build infrastructure areas for, e.g. wireless broadband access in residential areas or commercial areas. It may be used for temporary infrastructure build up, for example in an emergency situation, in a disaster area, or on the battlefield for military purposes. It could also be used to build up temporary access coverage areas during events like, for example, concerts, conferences, meetings, or seasonal tourist areas. In these kinds of areas, it is not necessary to have coverage all year around but only during specific periods, thus a fixed infrastructure build up in such a case may prove to be too expensive.

Today, several Internet Service Providers (ISP) offers wireless access at public or semi-public areas such as airports, restaurants, coffee shops, and hotels using fixed wireless infrastructure systems. These systems are often referred to as so called hotspots.

As the demand from the users to gain access increases considering coverage and bandwidth, one way of expanding the area of wireless coverage or bandwidth is to install more infrastructure components, however doing this with normal fixed wireless components are expensive and thus the idea to build networks using wireless routers has emerged. In this case ad hoc routing protocols may be used to have a simplified installation procedure.

There are basically two kinds of network usages when discussing ad hoc networks; the first one is the build up of a local area network without any external gateway providing access to an external network, for example Internet. This scheme may be found in installations concerning disaster areas or military installations on the battlefield. The other and probably more common usage is when one or several gateways provide the network with external connections to, for example, an IP (Internet Protocol) based network, private or public, e.g. Internet. In such a network configuration, data packets may take different routes and/or use different gateways depending on, for example, the data traffic type, congestions, or routing cost.

Packet based routing schemes often build there communication network systems around a layered model, for instance the OSI reference model. The communication software or hardware is divided into several smaller sub units, layers, working in a hierarchical manner. Information and communication control parameters are passed up and down locally and between the same layers between the sending and receiving ends. Each such layer is responsible for different tasks in the communication order. In respect to routing the first three layers according to the OSI reference model are the most important.

Layer 1 is responsible for the physical transmission of bits of data; examples of physical means may be, for instance, the wired link in an Ethernet based network or a wireless link in a Wireless Local Area Network (WLAN).

Layer 2 is often called the Link layer or the MAC layer and is responsible of transmitting chunks of data, error detection, and network resource coordination.

Layer 3 is often called the Network layer; it is responsible for enabling communication between any pair of nodes in a network. This layer takes, for example, care of routing calculations and some congestion control. For this purpose different routing protocols has been developed depending on the type of network.

Packet routing protocols in the IP-based networks are generally based on routing algorithms using distance vector or link state information to find and maintain a route for each pair of source and destination nodes in the network. In principle, in the distance vector routing algorithms, each router broadcasts the distance to all hosts to its neighbor routers, and each router receiving the information calculates the shortest route to each of the hosts in the network. In the link-state routing algorithms, each router broadcasts the status information of each of its adjacent network links to its neighbor routers, and each router receiving the information maintains the database of the entire picture of the network from the link status information and calculates the shortest route to each host based on the link costs in the database. These routing algorithms are designed for relatively static networks and thus new routing algorithms must be designed for ad hoc networks whose topology changes frequently.

There are basically two categories of existing routing protocols for ad hoc networks. These are “proactive” (table driven) and “reactive” (on-demand) routing protocols. Protocols having combinations of these protocols are also possible.

Proactive routing protocols constantly and periodically calculate a route to all hosts in the ad hoc network, and thus a route is always available when a packet needs to be sent to a particular destination host. The results are kept in routing tables in all nodes.

In order to maintain routes to each host, control messages are exchanged among the routers to notify changes of the network configuration and link status. Distance vector and link state routing protocols are both categorized as proactive protocols. It should be noted that control messages lead to overhead and may result in reduced network efficiency. Also, the proactive protocols may have difficulty in maintaining valid routes when the network topology changes frequently.

DSDV (Destination-Sequenced Distance Vector Routing) is a proactive routing protocol based on the distance vector algorithm, adapting the Routing Information Protocol (RIP) to ad hoc networks. Each node maintains a routing table in which the node stores the next hop node and hop count to each of all the reachable destination hosts. In DSDV, each node broadcasts or multicasts routing updates periodically, or when it detects changes of the network topology. Increnrental updates, which update only information about changes since the last update, are also used in order to reduce control traffic.

A reactive protocol only performs control message exchange to find/update a route when there is a data packet to be sent. When a source node wants to send data packets, it initiates the control protocol to find a route by sending a route request message to its neighbor nodes. By this principle, the reactive approach is good in that network resources are not wasted when there are no packets to be transported. However, it takes longer time to send packets when a route has to be formed for the first time. AODV and DSR are representative reactive protocols.

AODV (Ad hoc On-Demand Distance Vector Routing) protocol uses the DSDV algorithm and creates/updates routes on an on-demand basis, that is, only when a source node wants to send a data packet. This leads to reduction of the number of required broadcasts for finding/updating a route.

In AODV, each node maintains a list of detected neighbor nodes. The neighbor list is updated in one of the following three ways: a) when a packet is received from the neighbor node, b) by receiving local advertisement, that is, hello message, from the neighbor node, or c) through feedback from the link layer. Hello messages are broadcasted periodically from each node to its neighboring nodes to inform them about its presence.

In AODV, each node maintains a routing table for all the destinations, each of which the node is either communicating with or forwarding data packets to on behalf of other nodes. For each destination, there is an entry in the routing table that contains information about the destination, such as the IP address, the sequence number for the destination node, hop count to the destination, the next hop node to the destination, and lifetime for the route.

When a node wants to communicate with a destination node, that is, to send data packets to the destination, then the source node initiates a route discovery mechanism, where the source node broadcasts a route request (RREQ) to all detected neighbor nodes. When the neighbor node receives the RREQ message and has the entry for a fresh enough route to that destination in its routing table, then it sends back a route reply (RREP) message to the source node. If the neighbor node does not find a route entry for that destination, then it forwards the RREQ message to its own detected neighbor nodes. When the destination node receives the RREQ, it returns the RREP message to the source node.

In the process of forwarding the RREQ packet, each intermediate node records the IP address of the neighbor node from which the first copy of the broadcast RREQ is received, by which a reverse route is established. The copies of the same RREQ messages received later are all discarded. The intermediate nodes add an entry to their routing table for the destination, where the neighbor node from which the RREP was received is recorded as the next hop node for that destination. The destination sequence number and lifetime of the route are copied from the RREP and recorded in the entry. When the RREP message is returned to the source node finally, a forward route from the source to destination is formed.

When a node detects that a route becomes unavailable by failure of the incident link on the route, it sends a route error (RERR) message to all the neighbor nodes, which use the route. The RERR message is sent on to their neighbor nodes and so on until it reaches the source node. The source node can then decide to either stop sending data packets or initiate a new route discovery.

DSR (Dynamic Source Routing) protocol uses a source routing mechanism in which the source node determines the complete sequence of nodes along the route on an on-demand basis and sets the list of the intermediate nodes in the packet header to indicate the sequence of nodes for the route. In this way, each packet has to carry the overhead for packet routing. However, the intermediate nodes do not need to maintain any information about the route and they can learn routes when delivering data packets.

In DSR, each node stores (caches) the routes it has learned. When a source node wants to send data packets to a destination node and has no entry in the cache for that destination, then it initiates a route discovery mechanism by broadcasting a RREQ message on its link-layer. Each node receiving the RREQ message appends their IP addresses to the RREQ message and then forwards it further. This process is done until the route to the destination is found or another node can provide a route to the destination node. Then a route reply (RREP) message containing the sequence of network hops to the destination node is returned to the source node.

In DSR, when a link failure is detected at a node (i.e. when the packet has been retransmitted a maximum number of times), that node removes the link from its routes cache and sends a route error (RERR) message to each of the nodes that have used that link since an acknowledgement was last received. Those nodes have to remove the routes including that link. The retransmission of the data packet from the source node is then handled by upper layers such as the Transmission Control Protocol (TCP).

One problem with the TCP/IP protocol is that it only makes use of IP addresses and in a data link in an Ethernet or token ring example, the network components has its own addressing scheme to which any network layer using the data link must conform. In, for example, an Ethernet several different network layers can cooperate at the same time, several network applications can use the same physical cable. When an Ethernet frame or packet is sent from one location to another it uses a 48 bit Ethernet address for determining the destination and source of the packet. A unique 48 bit Ethernet address is found in all Ethernet networking hardware and often called the MAC address (Media Access Control). This 48 bit address can be compared with the 32 bit IP address used in IPv4 (Internet Protocol version 4). Address resolution provides the mapping scheme between the two different forms of addresses. This mapping is done by the ARP (Address Resolution Protocol). ARP provides the mechanism to dynamically map hardware MAC addresses to IP addresses in a temporary memory space called the ARP cache. In other words the ARP translates the IP address to a MAC address. However in IPv6 (Internet protocol version 6) the ARP function is not used, instead a neighbor discovery protocol (NDP) is implemented. NDP has many more and different functions built in as compared to the IPv4 ARP function.

IPv6 nodes on the same link use the Neighbor Discovery function to discover each other's presence, to determine each other's link-layer addresses, to find routers, and to maintain reachability information about the paths to active neighbors.

The Neighbour Discovery Protocol (NDP) for IPv6 is mapping addresses between the Network logical addresses and link-layer addresses (e.g. MAC addresses in an Ethernet based network). For example, the network layer protcocol IPv6 needs to map 128 bit IP addresses into Ethernet MAC addresses of 48 bits lengths. NDP stores the discovered mappings in a Neighbour Cache for later use. The NDP protocol is also used to maintain neighbour reachability information.

The basic operation of NDP for finding neighbours is as follows; when the IP layer wants to communicate with another device on the network, it checks for reachability in the Neighbour cache (to see if there is a match for a link-layer-address). If there is no entry in the neighbour cache (or unreachable status) a neighbour solicitation is issued to request the link-layer address to the target node. The target will respond to the solicitation with a neighbour advertisement containing its link-local-address. Upon reception of the advertisement, the neighbour cache will be updated.

NDP aims to solve the following problems related to link-local communication:
Router Discovery: Locate routers on an attached link. It helps hosts to identify local routers.
Prefix Discovery: Find the network prefix for the local area network which helps nodes to distinguish between local link addresses and addresses needed to be sent to a router for forwarding.
Parameter Discovery: Discovery of different link parameters, e.g. local link MTU (Maximum Transmission Unit).
Address Autoconfiguration: function used for IPv6 auto configuration purposes.
Address resolution: similar to the Address Resolution Protocol (ARP) used in IPv4, replaces both ARP and RARP functions.
Next-hop determination: used for determining the next destination, if this is on the local link or need to be routed.
Neighbour Unreachability Detection: used for determining if a node or router is still reachable.
Duplicate Address Detection: used for determining if an address is already used on the local link.
Redirect: Redirect information from a router. Used if a node sends packets to a router which may not be the best available router. The router may then redirect the node to send packets to a better router.

Neighbour Discovery works by defining five different ICMP packet types:
Router Solicitation: used for forcing routers to send router advertisements.
Router Advertisement: sent periodically to inform the network of their availability and contains relevant network information.
Neighbour Solicitation: used for forcing neighbouring nodes to send advertisements.
Neighbour Advertisement: used for sending their network information when being requested (through a neighbour solicitation) or when their link layer address has been changed.
Redirect: Routers send redirect messages to notify hosts that they are not the best router for a particular destination.

Only a ‘Source link-layer address’ option may be added in solicitations, according to the current standard. Receivers are silently ignoring any extra options that are not understood.

Only a ‘Target link-layer address’ option may be added in advertisements, according to the current standard. Receivers are silently ignoring any extra options that are not understood.

For the other NDP packet types mentioned above other options could be added.

This scheme works fine for fixed line networks, but in wireless ad hoc and/or multihop networks not all network units can hear each other, in this case the standard NDP solution will not suffice. For this purpose some different solutions for finding hosts in the network have been developed.

The problems with the above mentioned solutions can be summarized as follows:
1. Standard NDP enables only local peer-to-peer communication in a wireless network.
2. The existing ad hoc routing protocols have the status of Internet Drafts and therefore not finalized. This is due to lack of experience in this field since IPv6 is not widely deployed yet.
3. Existing wireless communication systems do not consider the link quality between sender and receiver.

Accordingly the above mentioned solutions will not be transparent for an implementer of such a network solution in a standard IP based network and will take up extra resources both from the available network resources and from the computing power of the involved routing components.

### SUMMARY OF THE INVENTION

Thus, it is one object of the preferred embodiment of the present invention to remedy at least some of the above mentioned problems and drawbacks.

This is done by introducing new features in NDP (Neighbor Discovery Protocol) messages without changing the NDP message structure. In this way, network components using standard NDP functionality will not be affected by this new NDP message structure. However, network components using an NDP solution according to the present invention will be able to make use of an efficient NDP mapping.

In one preferred embodiment of the present invention, a method for “neighbor discovery” is provided for a wireless multihop data communication network using Internet Protocol (IP) and specially IP version 6 (IPv6), the method comprising the steps of: broadcasting an neighbor discovery protocol (NDP) solicitation from a first network node to a second node or nodes; the second node receiving the NDP solicitation determining the destination of the NDP message; retransmitting the NDP solicitation if the NDP solicitation is determined to be destined to a third node; and forwarding NDP advertisements from a destination network node to the first network node via intermediary network node or nodes.

The method further comprises a pending list of stored detected previous NDP solicitations and NDP advertisement forwards in the nodes.

The method may further comprise the steps of limiting the storage time in the pending list of the stored previous NDP solicitations or advertisements, limiting the rate of NDP advertisement forwards a node are allowed to send to a specific destination, measuring link quality between nodes and distributing link quality information to nodes during NDP message procedures, using the link quality information to determine when a NDP Neighbor Cache should be updated, comparing the link quality information with a threshold value in order to determine if an update is to be done, and modifying the NDP solicitation prior to rebroadcasting or forwarding the NDP solicitation.

According to the method, NDP error message may be generated and distributed to listening nodes in the network when a node can not communicate with a certain node.

In another embodiment of the present invention, a communication device is presented wherein the device has routing means in a multihop wireless network, and the device comprises: an instruction set memory; at least one wireless transceiver; means for providing neighbor discovery protocol (NDP) instructions in the instruction set memory and means for providing NDP message forwarding and rebroadcasting instructions in the instruction set memory.

In the device, the means for NDP advertisement forwarding and NDP solicitation broadcasting may include means for determining the destination of an NDP message.

The device may be a client or a server system, such as, but not limited to, laptop, personal computer (PC), workstation, personal digital assistant (PDA), mobile phone, or embedded computer or infrastructure system, such as, but not limited to, WLAN (Wireless Local Area Network) infrastructure devices, and mobile phone infrastructure devices.

The NDP forwarding or rebroadcasting instructions may modify the NDP message to appear to originate from the device modifying the message.

In yet another embodiment of the present invention, a system for multihop wireless data communication is presented, the system comprises: a plurality of communication devices; the communication devices comprising: an instruction set memory; at least one wireless transceiver; means for providing neighbor discovery protocol (NDP) instructions in the instruction set memory; and means for providing NDP forwarding and rebroadcasting instructions in the instruction set memory; and a communication network built up by the communication devices.

The communication device in the data communication system further comprises means for determining the destination of the NDP message.

The communication device may be a client system, server system, infrastructure system, or a combination of these types of devices. Examples of client and server systems may be, but not limited to, a laptop, personal computer (PC), workstation, personal digital assistant (PDA), mobile phone, or embedded computer. Examples of infrastructure systems may be, but not limited to, a WLAN (Wireless Local Area Network) infrastructure devices, and mobile phone infrastructure devices.

The system may further comprise at least one gateway connected to an external network, such as Internet or a private IP network.

The invention also relates to an instruction set for “neighbor discovery” in a wireless multihop data communication network, the instruction set comprises: a first instruction set for broadcasting a neighbor discovery protocol (NDP) solicitation from a first network node to a second node; a second instruction set in the second node for receiving the NDP solicitation determining the destination of the NDP solicitation; a third instruction set transmitting the NDP solicitation if the NDP solicitation is determined to be destined to a third node; and a fourth instruction set for forwarding NDP advertisements from the third node to the first network node via the second node(s).

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates in a schematic way a small multihop network.

FIG. 2 is a flow diagram over small multihop network with the different communication messages.

FIG. 3a illustrates a schematic message structure of NDP ICMPv6 used for solicitation.

FIG. 3b illustrates a schematic message structure of NDP ICMPv6 used for advertisement

FIG. 4 illustrates a schematic of a larger multihop wireless network in connection with a fixed network.

FIG. 5 is a block diagram of a node according to the present invention.

FIG. 6 is a block diagram of a method according to the present invention.

### DETAILED DESCRIPTION OF THE INVENTION

The present invention relates to the concept of mobile ad hoc networks, wherein a self-organizing wireless network of mobile nodes communicates with each other using a so called multihop routing system. The nodes act as both hosts/client systems and routers, i.e. infrastructure devices. Traffic is routed via the nodes and if necessary routed to external gateways having access to an external IP network, e.g. Internet.

In a preferred embodiment of the present invention, a new solution for NDP (Neighbor Discovery Protocol) as part of Internet Protocol version 6 (IPv6) is presented wherein NDP messages are forwarded to recipient nodes using intermediary nodes situated in the path between the NDP solicitation node and the final recipient of the NDP message.

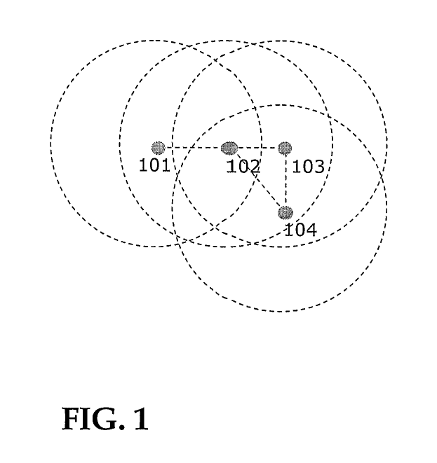

In FIG. 1 a number of network nodes 101, 102, 103, and 104 are illustrated for a multihop wireless network. The nodes 101, 102, 103, and 104 are in communication with each other, however not all nodes have contact with each other. This means that in some situations some nodes will relay messages and act as routing elements. For instance, if node 101 wants to communicate with node 104 nodes 102 or 102 and 103 need to be involved in the packet transactions since the nodes 101 and 104 can not in this situation directly “hear” each other, i.e. can not directly communicate with each other.

When a message is to be sent from one node to another node the network addresses of the nodes need to be resolved. In the present invention a new NDP procedure is proposed wherein new NDP messages are added to enable NDP message structure is changed in such a way that NDP advertisement forwarding or NDP solicitation rebroadcasting. This means that nodes lying in between two nodes that need to know each others network addresses will forward such NDP solicitations until the NDP solicitations reaches the sought after destination.

Let us illustrate this with a schematic stepwise procedure assuming node 101 wants to communicate with node 104 according to FIG. 1:
1. Node 101 wants to send data to node 104.
2. Automatically node 101 broadcasts an NDP Solicitation: “Who is 104, tell 101?”.
3. This solicitation message is received by the adjacent node 102, which immediately rebroadcasts the request: “Who is 104, tell 102?”.
4. This solicitation is received by the adjacent node 103, which rebroadcasts the solicitation: “Who is 104, tell 103?”. However, in this specific case the request is also received by node 104, who replies by sending an NDP advertisement: “Node 102, I am 104”.
5. The solicitation transmitted by node 103 is received by node 104, who replies by sending an NDP advertisement: “Node 103, I am 104”.
6. The reply from node 104 to node 102 is received by node 102.
7. Node 102 replies to the origin of the request (node 101) by sending an NDP advertisement forward: “Node 101, use node 102 as gateway to node 104”.
8. The advertisement from node 104 to node 103 is received by node 103. Node 103 sends an advertisement forward to node 102 by sending: “Node 102, use node 103 as gateway to node 104”.

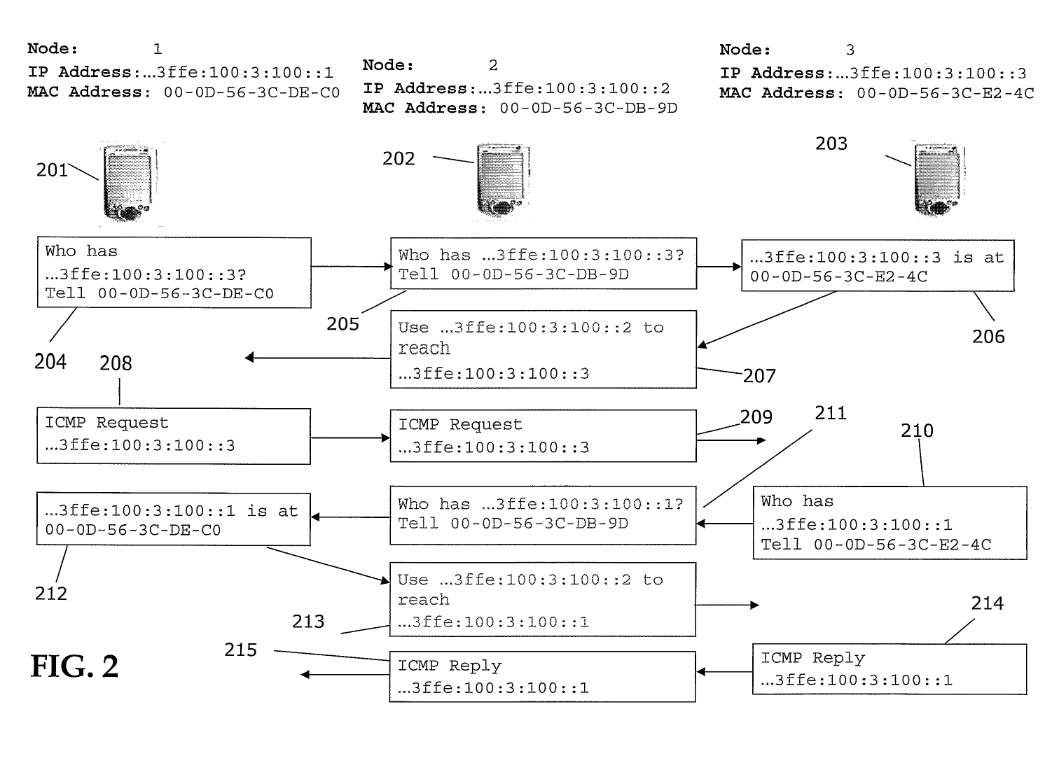

In another example as shown in FIG. 2, three nodes (201, 202, and 203) are connected in a small network. Node 201 wants to communicate with node 203 but can not do so directly. However, node 202 is positioned in such a way that it can relay messages between node 201 and 203. In FIG. 2 node 201 wants to send an ICMP (Internet Control Message Protocol) echo request, which for instance forms the basis of the commonly known “ping” function, to node 203. The message boxes 205, 207, 211, and 213 in FIG. 2 are indicating the new message types communicated between the nodes according to the present invention.
1. When node 201 starts its communication procedure it first sends an NDP Solicitation message asking for the location of the IP address it wants to communicate with. This is illustrated in box 204.
2. This NDP Solicitation is received by node 202. Node 202 determines that the message is meant for another node than itself. The solicitation message is altered to appear to come from node 202, and rebroadcasted by node 202 as illustrated in box 205.
3. The message is received by node 203 and an NDP advertisement is sent to node 202 (box 206) and node 202 forwards the NDP advertisement to node 201 (box 207).
4. Node 201 then has the coordinates for node 203 and sends the ICMP request to node 203 (box 208) and the ICMP request is relayed by node 202 (box 209).
5. Node 203 receives this ICMP request and then wants to send an ICMP reply. However, it needs to know the link-layer address of node 201 in order to send the reply and therefore sends an NDP solicitation for node 201. This is illustrated in box 210.
6. This message is received by node 202. Node 202 determines that the solicitation message is meant for another node than itself. The message is altered to appear to come from node 202, and rebroadcasted by node 202 as illustrated by box 211.
7. The message is received by node 201 and an NDP advertisement is sent to node 202 (box 212) and node 202 forwards the NDP advertisement to node 203 (box 213).
8. Node 203 then has the coordinates for node 201 and sends the ICMP reply (box 214) which is relayed by node 202 (box 215) to node 201 and the ICMP communication procedure is finalized.

The above described communication method has been illustrated by an ICMP echo request but it should be appreciated by the person skilled in the art that any type of communication procedure, protocol, or scheme may be used within the scope of the present invention. Also, the person skilled in the art should understand that more than three nodes may be involved in the communication network and transaction of traffic.

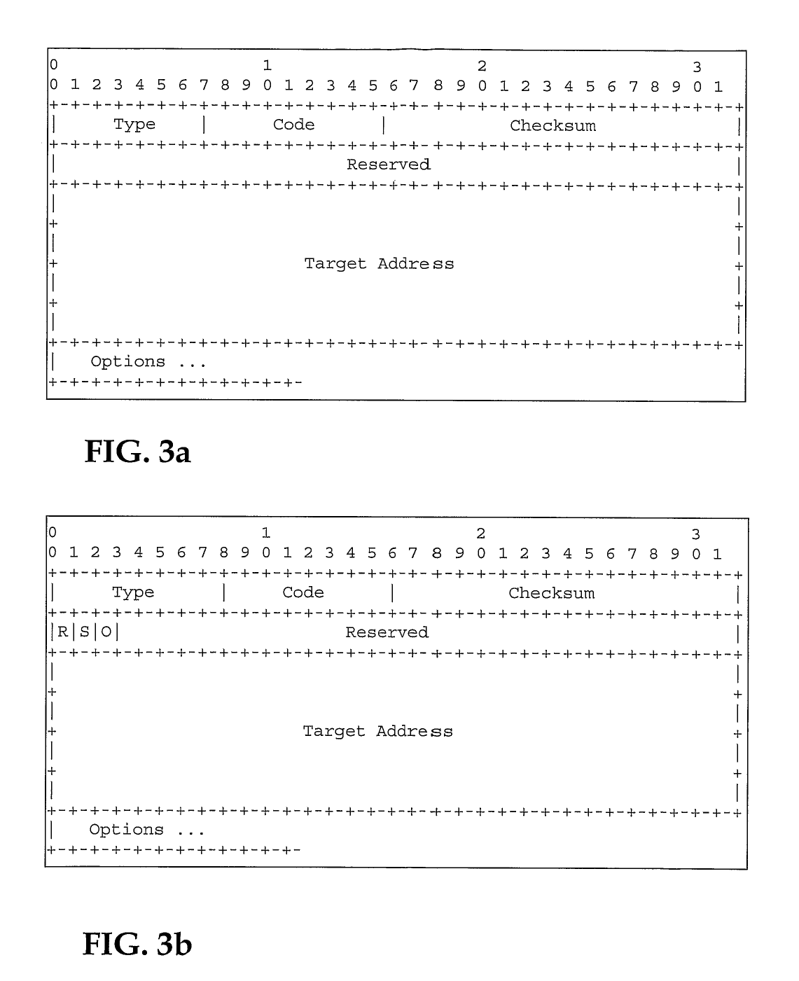

FIGS. 3a and 3b illustrates NDP solicitation and advertisement messages respectively according to the standard Internet Protocol version 6 (IPv6).

The above mentioned messages are not all part of the standard NDP procedure. However, even the non standard messages may be incorporated into a standard message by using the options field in message headers and/or new message types. For the options field case routing elements conforming to standard NDP solicitations will be able to handle NDP solicitations made by routing elements using the present invention's new NDP forwarding scheme. Standard routing element will only ignore such new NDP message types. Modified routing elements enabled to handle the present invention's new NDP forwarding scheme will be able to make use of the new codes included in the options field and/or new message types. The options field defines what type of message is transmitted or received. Therefore it is not necessary to change the NDP standard in order to implement the NDP forwarding scheme. To accomplish NDP advertisement forward, NDP error, and NDP link quality, new message types and options are proposed in the present invention. The new NDP control message types will now be described:

NDP Advertisement Forward: Any routing device with an implementation according to the present invention, understands that this message is an NDP advertisement forward message and treats it as an NDP advertisement with some differences in message handling. It is also a function in the implementation of the NDP advertisement forwarding scheme introduced in the present invention. This function relay routes to nodes. The message contains the final destination and what the nearest hop to the final destination is.

NDP error is generated when a node realizes that it can not communicate with a certain node. This is generated if the node is unable to find any alternative routes to the certain sought after node. The NDP error message is broadcasted (to adjacent nodes, i.e. single-hop neighbors) and contains information about which node generated the error message and the node that can not be reached. The NDP error generating node removes all entries to routes containing the missing node and all routes where the missing node acts as a gateway. Receivers of the NDP error message broadcasted removes any active routes containing the missing node. If no alternative routes exist in the receiving node an NDP error message is generated and broadcasted.

NDP link quality message contains information about the link quality between two nodes.

It should also be considered that messages rebroadcasted by intermediary nodes are also received by previous nodes in the communication chain. In the example of FIG. 2, when node 202 rebroadcast an NDP solicitation, node 201 will receive the same message. In order to reduce the amount of control traffic every node may keep track of every request and reply by locally storing a pending list at every node. By looking in this list of recent requests and replies before forwarding an NDP solicitation, a node may be able to reduce the amount of control traffic broadcasted on the network infrastructure. If a message received is determined to be concerning a node set already in the pending list, it will be discarded. In the pending list, information about which node is asking for which node, at what time this request was done, if any reply has been received, and if a reply has been forwarded to another node are stored.

In the solution it is also possible to introduce a time limit on how often or when a node may rebroadcast a request destined for a specific node. When a request travels two or more different paths and is received at a node it should not be forwarded more than one time. This is solved by not allowing a node to forward a request to a specific node within a certain time limit. Vice versa, NDP advertisement or forward messages are only allowed to be sent once to every origin as long as no rebroadcast has been sent.

Since the present invention do not change the NDP standard no special NDP initiation routines is necessary. However, in another embodiment of the present invention a link quality supervision system may be introduced together with the above mentioned NDP solution in order to further reduce the amount of control traffic and increasing the traffic speed. By measuring the link quality between nodes, for instance the radio quality, acknowledgement information, bit error rate, or data rate throughput (from for example Transmission Control Protocol, TCP), it is possible to upon a detected link quality reduction, pro-actively update NDP listings. Such a scheme may reduce the amount of lost data packets and reduces the amount of control traffic in the infrastructure. In PCT/SE03/002074 (incorporated herein through reference) a similar scheme for link quality surveillance in an ad hoc network is introduced. The same system may be used for deciding when to update a routing and/or a Neighbor Cache table. It is possible to have multiple routes in a Neighbor cache and routing table, these routes may be marked as active or inactive depending on route status.

Controllable parameters in the NDP implementation according to the present invention include, but is not limited to, how often a node may rebroadcast NDP solicitation, how long time an entry in the pending list is valid and the amount of time a routing entry and a neighbor entry not in use will be stored in the routing table and the NDP Neighbor Cache.

Requests are stored in a receiving node in such a way that the receiving node can send a reply to a requesting node if a reply is received from other nodes.

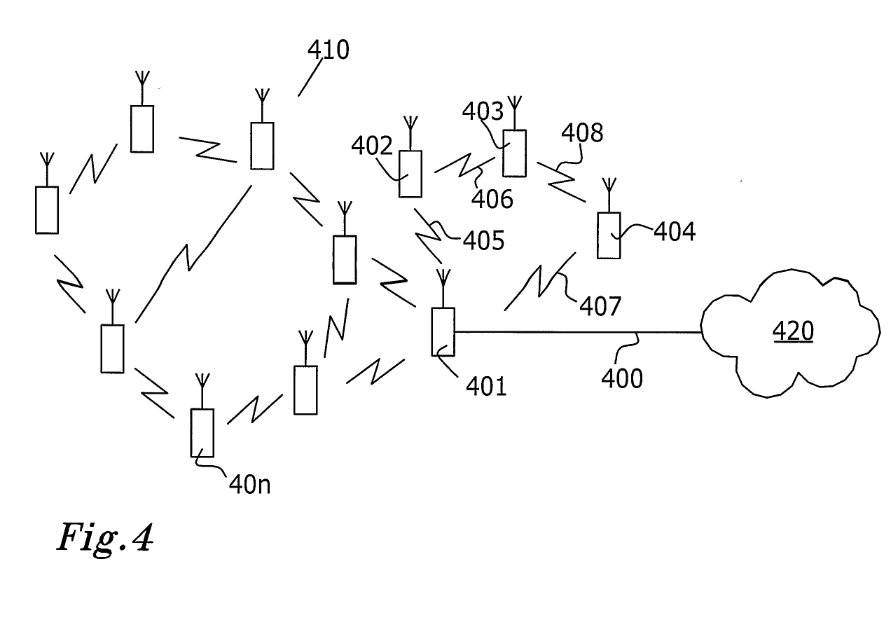

The invention may be used both for independent networks where no external connection is provided, such as in for instance a disaster area network setup or military network setup on the battlefield, and for a cluster of wireless components connected together and in the cluster there are at least one connection to an external network (e.g. Internet or an independent IP network). The latter embodiment is illustrated in FIG. 4 wherein a plurality of wireless components 402 . . . 408, and 40n (wherein n is an integer) are connected to a gateway 401 with a connection 400 to an external network 420, for instance Internet. The external connection 400 may be of any suitable type, including but not limited to, for LAN or WAN connectivity through a fixed wired connection (e.g. Ethernet, Token Ring, Local Talk, X.25, ATM, ADSL, ISDN, or even an optical fiber connectivity link Ethernet, optical fiber, or similar), or “fixed” wireless (e.g. WLAN (e.g. 802.11 series), LMDS (Local Multi-point Distribution Service), GSM, GPRS, or 3G).

The communication scheme is independent on the radio-coding scheme used and any radio type may be used. For example, radio standards as of in the IEEE 802.11 series (e.g. IEEE 802.11a, IEEE 802.11b, IEEE 802.11g and so on), IEEE 802.15, IEEE 802.16, HiperLAN, HomeRF, Bluetooth, IR (Infrared), UWB (Ultra WideBand), JTRS (Joint Tactical Radio System), 3G (Third Generation mobile communication), GPRS (General Packet Radio Service), or EDGE (Enhanced Data rate for Global Evolution). However the possible radio standards are not limited to the above mentioned. It may be any suitable electromagnetic radiation based transmission scheme operating within the frequency band of 100 kHz to 100 PHz; this includes radio frequencies, microwave frequencies, and frequencies in the infrared, visible, and ultraviolet regimes.

The NDP method according to the present invention may be used in many different application areas such as, for example, by the police in general or during special events, rescue forces during a disaster or an accident, military forces on the battlefield or in training, or for building wireless access areas for communication purposes both for residential and commercial network access. For example it is possible to use these ad hoc networks to build up broadband access using short range, low cost, wireless equipment in residential areas where other broadband access technology is scarce or too expensive to connect to. It may also be used in commercial districts for either providing broadband access to enterprises or small companies, or for wireless connections at so called hotspots. Hotspots are characterized in that they provide communication access within a certain area, for example at an airport lounge or in hotels, for paying customers or for free depending on business model.

A node may be any computational device including, but not limited to, a laptop, personal computer, workstation, personal digital assistant (PDA), embedded computer, or mobile phone. Such a device include at least one wireless transceiver and an instruction set memory with programming code handling neighbor discovery protocol instructions and neighbor discovery protocol forwarding and rebroadcasting instructions. The device also includes means in the instruction set memory for determining the final destination of messages and means for modifying NDP messages according to the present invention.

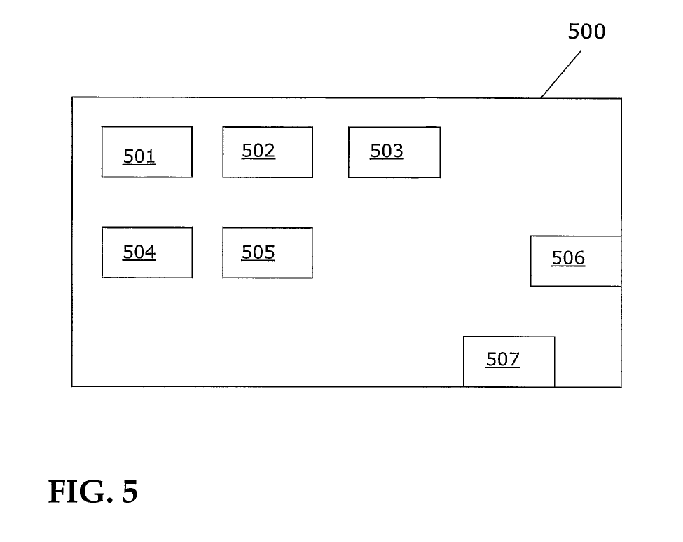

FIG. 5 illustrates schematically a node 500 for use in a network according to the present invention. The node comprise at least a computational unit 501 such as a processor or similar and a wireless interface 506. The wireless interface may have connection means in order to connect a signal to an external antenna or antennas (not shown). The computational unit 501 may be used for running e.g. routing software, link quality software, and neighbor discovery protocol software according to the present invention. Additionally the node 500 may include a LAN and/or WAN connectivity means 507, such as e.g. Ethernet, Token Ring, Local Talk, X.25, ATM, ADSL, ISDN, WLAN e.g. from 802.11 series), GPRS, GSM, 3G, or even an optical fiber connectivity link. Nodes including the LAN and/or WAN connectivity may act as a gateway 401 (as shown in FIG. 4) in a network according to a preferred embodiment of the present invention. The node may also include volatile 502 and non-volatile 503 memory units, and other units 504, 505 as may be found in many computational devices (e.g. computers, PDAs, laptops, and so on), these other units may for instance be input and output control units, serial communication control units, or similar functions. The node in FIG. 5 has been illustrated with one wireless interface 506, however, the person skilled in the art may appreciate that more than one wireless interface may be used, e.g. two interfaces may be used in order to separate access and infrastructure transmissions from each other in order to increase network stability and data throughput.

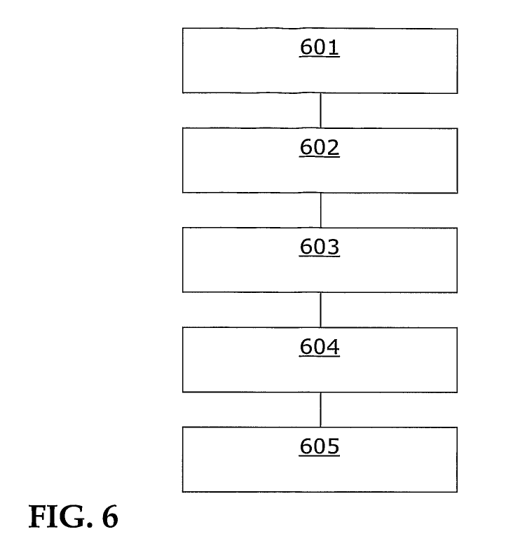

FIG. 6 depicts a schematic illustration of a method according to the present invention. This method for “neighbor discovery” may be illustrated by the steps in FIG. 6 as follows:
1. A node broadcasts a neighbor discovery protocol solicitation (box 601);
2. A second node or nodes receives this solicitation (box 602);
3. The second node or nodes determines if the solicitation is destined for the second node or nodes (box 603);
4. if the solicitation was determined to be destined to a third node, the solicitation is re-transmitted (box 604); and
5. forwarding NDP advertisements from a destination network node to the first network node via intermediary network node or nodes (box 605).

Even though in the examples above three or four nodes have been used for illustrating the present invention, it should be appreciated by the person skilled in the art that more or less number of nodes may be used in such a network installation. There is no special limit on the number of nodes involved.

Although the invention has been described in detail for the purpose of illustration, it is to be understood that such detail is solely for that purpose and that variations can be made therein by those skilled in the art without departing from the spirit and scope of the invention except as it may be limited by the following claims.

1. A method for detecting adjacent nodes, so called “neighbor discovery” in a wireless multihop data communication network using Internet Protocol (IP), and specially Internet Protocol version 6 (IPv6), the method comprising the steps of:
broadcasting an neighbor discovery protocol (NDP) solicitation from a first network node (101) to a second node (102);
said second node (102) receiving said NDP solicitation determining the destination of said NDP solicitation;
transmitting said NDP solicitation if said NDP solicitation is determined to be destined to a third node (104); and
forwarding NDP advertisement from a said third node (104) to said first network node (101) via said second node(s) (102, 103).

2. The method according to claim 1, wherein said second node (102, 103) comprises a plurality of nodes.

3. The method according to claim 1, further comprising arranging a pending list of stored detected previous NDP solicitations and NDP advertisement forwards in said nodes.

4. The method according to claim 3, further comprising the step of limiting the storage time in the pending list of the stored previous NDP solicitations or NDP advertisement forwards.

5. The method according to claim 1, further comprising the step of limiting the rate of NDP advertisement forwards a node are allowed to send to a specific destination.

6. The method according to claim 1, further comprising the step of measuring link quality between nodes and distributing link quality information to nodes during NDP message procedures.

7. The method according to claim 1, wherein said link quality information comprises at least one of acknowledgement information, radio link quality, data rate throughput, and bit-error rate.

8. The method according to claim 6, further comprising the step of using said link quality information to determine when at least part of an routing and/or NDP Neighbor Cache table should be updated.

9. The method according to claim 6 , further comprising the step of comparing said link quality information with a threshold value in order to determine if an update is to be done.

10. The method according to claim 1, wherein an NDP error message is generated and distributed to listening nodes in said network when a node cannot communicate with a certain node.

11. The method according to claim 1, further comprising modifying said NDP solicitation prior to rebroadcasting or forwarding said NDP solicitation.

12. A communication device (500) with routing means in a multihop wireless network using Internet Protocol (IP), especially IP version 6 (IPv6), said device comprising:
an instruction set memory (502);
at least one wireless transceiver (506);
means for providing neighbor discovery protocol (NDP) instructions in said instruction set memory; and
means for providing NDP message forwarding and rebroadcasting instructions in said instruction set memory.

13. The device (500) according to claim 12, wherein said means for NDP advertisement forwarding and NDP solicitation broadcasting include means for determining the destination of an NDP message.

14. The device (500) according to claim 12, wherein the communication device is a client system or server system.

15. The device (500) according to claim 14, wherein said client system may be one or several of laptop, personal computer (PC), personal digital assistant (PDA), mobile phone, or embedded computer.

16. The device (500) according to claim 12, wherein the communication device is an infrastructure system.

17. The device (500) according to claim 16, wherein said infrastructure system is one or several of WLAN (Wireless Local Area Network) infrastructure devices, and mobile phone infrastructure devices.

18. The device (500) according to claim 12, wherein said NDP advertisement forwarding or NDP solicitation rebroadcasting instructions modify said NDP message to appear to originate from the device.

19. A system for multihop wireless data communication in a packet based network using Internet Protocol, and specially Internet Protocol version 6 (IPv6) said system comprising:
a plurality of communication devices (401, 402 . . . 408, 40n);
said communication devices comprising:
an instruction set memory (502);
at least one wireless transceiver (506);
means for providing neighbor discovery protocol (NDP) instructions in said instruction set memory; and
means for providing NDP advertisement forwarding and NDP solicitation rebroadcasting instructions in said instruction set memory; and
a communication network (410) built up by said communication devices.

20. The system according to claim 19 said communication device further comprising means for determining the destination of said NDP message.

21. The system according to claim 19, wherein said communication device is a client or server system.

22. The system according to claim 21, wherein said client or server system may be one or several of laptop, personal computer (PC), workstation, personal digital assistant (PDA), mobile phone, or embedded computer.

23. The system according to claim 19, wherein said communication device is an infrastructure system.

24. The system according to claim 23, wherein said infrastructure system may be one or several of WLAN (Wireless Local Area Network) infrastructure devices, and mobile phone infrastructure devices.

25. The system according to claim 19, further comprising at least one gateway connected to an external network.

26. An instruction set for “neighbor discovery” in a wireless multihop data communication network using Internet Protocol, and specially Internet Protocol version 6 (IPv6), the instruction set comprising:
a first instruction set for broadcasting a neighbor discovery protocol (NDP) solicitation from a first network node to a second node;
a second instruction set in said second node for receiving said NDP solicitation determining the destination of said NDP message;
a third instruction set transmitting said NDP solicitation if said NDP solicitation is determined to be destined to a third node; and
a fourth instruction set for forwarding NDP advertisements from a said third node to said first network node via said second node(s).
